(19) United States
(12) Patent Application Publication
(10) Pub. No.: US 2010/0269355 A1
(43) Pub. Date: Oct. 28, 2010

(54) Control method for motor-driven shears

(76) Inventors: Dezhong Yang, Nanjing (CN); Junya Duan, Nanjing (CN)

Correspondence Address: MCDERMOTT, WILL & EMERY LLP;Attn: IP Department, 227 WEST MONROE STREET, SUITE 4400, CHICAGO, IL, 60606-5096, US

(21) Appl. No.: 12/799,347

(22) Filed: Apr. 22, 2010

(30) Foreign Application Priority Data
Apr. 28, 2009 (CN) 200910031464.8

(51) Int. Cl. B23Q 5/02

(52) U.S. Cl. 30/228

(57) ABSTRACT

The present invention relates to a control method for motor-driven shears. The control method for the motor-driven shears of the present invention requires that both the power supply module and the control system used to drive the motor be active simultaneously for the shears to operate. The power supply module requires a switch be pressed to activate the power supply module and to provide the resultant power to the MCU. Further, upon releasing the switch, the MCU is be able to maintain the power supply module in a discharging state long enough to allow the control system controlling the motor to rotate the movable blade to an open position. Finally, when the movable blade is opened to a maximum position, the MCU may direct the motor to stop rotation and shut off the power supply module.

### CROSS-REFERENCE TO RELATED APPLICATIONS

This application claims priority under 35 U.S.C. §119 to CN 200910031464.8 filed Apr. 28, 2009, which is hereby incorporated by reference.

### FEDERALLY SPONSORED RESEARCH OR DEVELOPMENT

Not Applicable.

### TECHNICAL FIELD

The present invention relates to a control method for motor-driven shears. More particularly, to a secure control method for motor-driven shears.

### BACKGROUND OF THE INVENTION

As a type of motor-driven tool, motor-driven shears may have shears for cutting thick fibers like those found in carpets, shears for cutting cable wires, or shears for cutting branches. These motor-driven shears generally include a fixed blade and a movable blade. These two blades form a cutting mouth between them. The movable blade is driven by the positive or negative rotation of the motor. The rotation of the motor results in the movable blade moving in a swinging motion so that the cutting mouth can open and close repeatedly and continuously. In order to reduce accidents during operation, the motor-driven shears should conform with the relevant provisions of the appropriate safety standards. For example, the safety standards related to shears for cutting tree branches require that the cutting mouth of the shears open automatically to a maximum position when the shears are turned off.

To meet the requirements of the preceding safety standards, those skilled in the art may consider using a controller chip like a Micro Controller Unit (MCU), to achieve programmable control of the shears. However, this proposed solution is not without issues. If the MCU malfunctions or is damaged, the MCU may transmit an incorrect instruction. For example, if the shears are not turned on, but the MCU malfunctions, the motor may begin to rotate and drive the blades in a cutting motion. This type of unintended operation may result in significant injury to a user.

### SUMMARY OF THE INVENTION

The present invention provides an improved control method for motor-driven shears to overcome the issues and deficiencies of the prior art described above. The motor-driven shears of the present invention can effectively prevent the safety risks caused by a failure of the MCU, and thereby improve the security of the motor-driven shears.

The control method for the motor-driven shears of the present invention requires that both the power supply module and the control system used to drive the motor be active simultaneously for the shears to operate. The power supply module requires a switch be pressed to activate the power supply module and to provide the resultant power to the MCU. Further, upon releasing the switch, the MCU is be able to maintain the power supply module in a discharging state long enough to allow the control system controlling the motor to rotate the movable blade to an open position. Finally, when the movable blade is opened to a maximum position, the MCU may direct the motor to stop rotation and shut off the power supply module.

Only when the outputs of the switch and the MCU are active simultaneously will the MCU of the motor-driven shears of the present invention provide for the rotation of the motor to achieve a cutting movement. Effectively, this implementation prevents the risks caused by any malfunctions or failures of the MCU and improves the security of the motor-driven shears.

### BRIEF DESCRIPTION OF THE DRAWINGS

The present invention will be further described with reference to the accompanying figures.

FIG. 1 is an illustrative view of a preferred embodiment of branch-pruning shears according to the present invention;

FIG. 2 is a circuit schematic of a first technical solution for the control system of the branch-pruning shears;

FIG. 3 is a partial circuit schematic of a control system for the branch-pruning shears in FIG. 2;

FIG. 4 is a circuit schematic of a second technical solution for the control system of the branch-pruning shears; and

FIG. 5 is a partial circuit schematic for the control system of the branch-pruning shears in FIG. 4.

### DETAILED DESCRIPTION

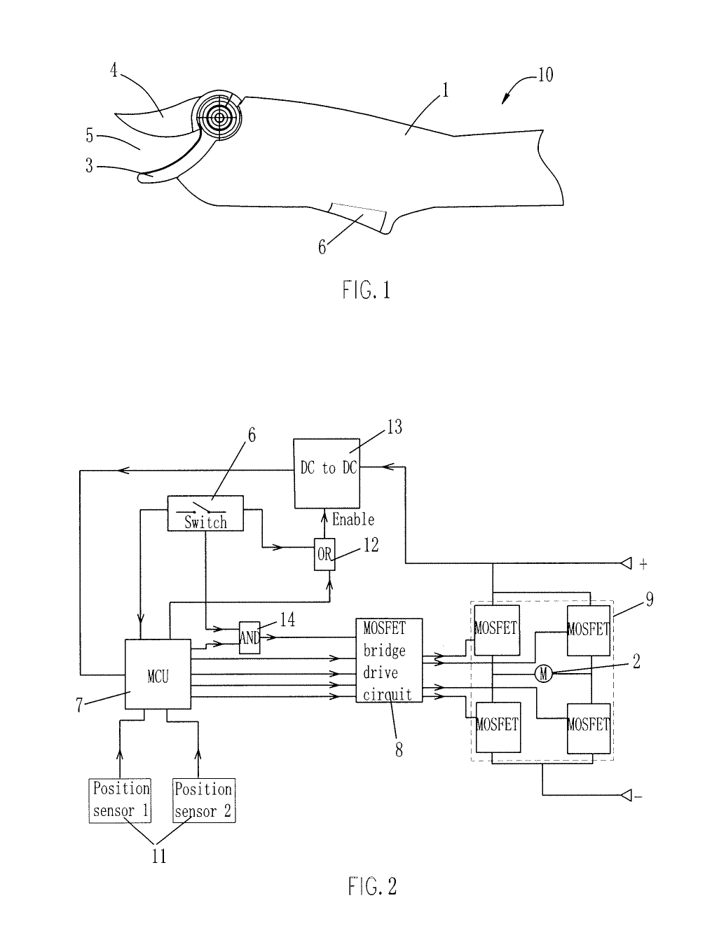

There are various shapes and kinds of the motor-driven shears. As an example, a first embodiment implements branch-pruning shears. Referring to FIG. 1, the branch-pruning shears 10 include a housing 1 in which a motor 2 (not shown) is installed. The cutter portion of the branch-pruning shears 10 is comprised of a fixed blade 3 and a movable blade 4, wherein the fixed blade 3 is fixed relative to the housing 1, and the movable blade 4 is connected to the motor 2 by a transmission device. A cutting mouth 5 is formed between the fixed blade 3 and the movable blade 4. A switch 6 is mounted on the housing 1. To allow for many different uses and various operating situations, the branch-pruning shears 10 may be powered by a battery pack (not shown) which can be disposed on an end of the housing 1.

Referring to FIG. 2, it shows a circuit schematic of a first embodiment of a control system for the branch-pruning shears 10. In order to meet the requirements of the relevant safety standards (i.e. the cutting mouth is opened automatically to a maximum position when the switch is shut off), the branch-pruning shears 10 are provided with a MCU 7 to ensure compliance with the safety standards. As shown in the figure, the MCU 7 is connected to two position sensors 11. The first and second position sensors 11 may induce an opened position and a closed position of the movable blade 4, and transfer respective signals to the MCU 7. The MCU 7 may be connected to the motor 2 and a full-bridge circuit 9 through a MOSFET bridge drive circuit 8. The full-bridge circuit 9 may be composed of four MOSFETs. The MCU 7 controls the positive/negative rotation of the motor 2 according to the output signals of the position sensors 11 and drives the movable blade 4 to move in a swinging motion by the transmission device. As a result, the cutting mouth 5 may be opened and closed repeatedly and continuously to implement the cutting operation. In this embodiment, the position sensors 11 may be Hall sensors. In other embodiments, position sensors 11 may be replaced by other appropriate sensors.

Further, the MCU 7 and switch 6 are connected to a power supply module 13 through an OR gate circuit 12. Thus, when the switch 6 is moved to an off position, the MCU 7 can still be powered by the power supply module 13. As a result, the motor 2 is able to drive the movable blade 4 to an open position until the cutting mouth 5 is opened to the maximum position. When the movable blade 4 is in the maximum open position, the first position sensor 11 can transfer output signals to the MCU 7, causing the MCU 7 to stop the rotation and shut off the power supply module 13 of the MCU 7.

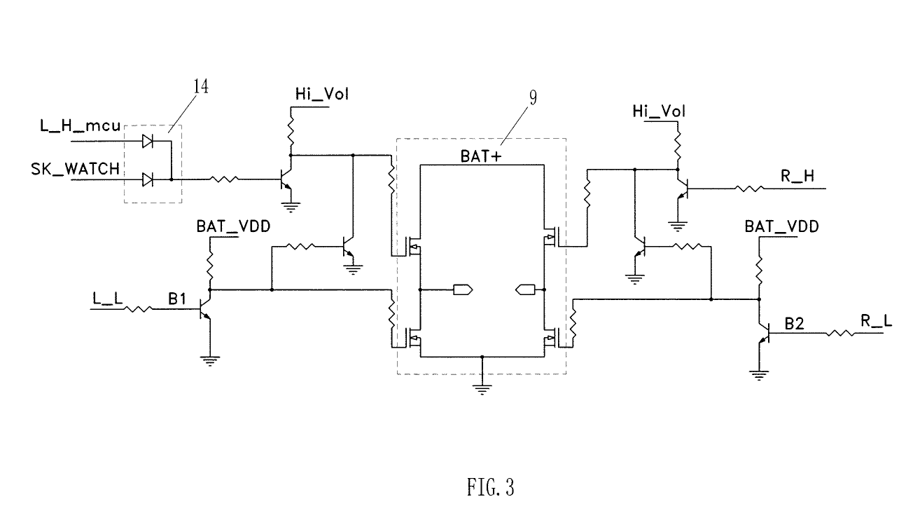

In order to prevent the MCU 7 from sending out the wrong instructions when it is damaged or malfunctioning, the control system also contains an AND gate circuit 14. As shown in FIG. 2, the MCU 7 and the switch 6 may be connected to the MOSFET bridge drive circuit 8 through an AND gate circuit 14 which is independent of the MCU 7. As a result, only when the switch 6 is pressed and the MCU 7 sends out the proper instructions will the MOSFET bridge gate circuit 8 cause the motor 2 to rotate. On the contrary, if the switch 6 is not pressed, but because of a failure, the MCU 7 attempts to send out instructions, the motor 2 will not rotate. Accordingly, this structure can effectively prevent the risks caused by a failure of the MCU. As shown in FIG. 3, the AND gate circuit 14 may be composed of two diodes. In other embodiments, it may also be composed of other appropriate devices, such as triodes and the like.

The control method of the branch-pruning shears 10 of the present invention may require a user to press the switch 6 thereby actuating the power supply module 13 to power the MCU 7. As a result, the MCU 7 drives the full-bridge circuit 9 through the MOSFET bridge drive circuit 8 to drive the motor 2 to rotate when the outputs of the switch 6 and the MCU 7 are active simultaneously. Then the MCU 7 instructs the motor 2 to rotate positively or negatively according to the output signals of the position sensors 11, so that the movable blade 4 is driven to move in a swinging motion to implement the cutting operation. When the switch 6 is released, the MCU 7 instructs the motor 2 to rotate reversely, so as to drive the movable blade 4 to move towards an open position until the opening of the cutting mouth 5 is opened to a maximum position. When the cutting mouth is in a maximum open position, the first position sensor 11 transfers the signals to the MCU 7, and the MCU 7 instructs the motor 2 to stop the rotation and shut off the power supply module 13.

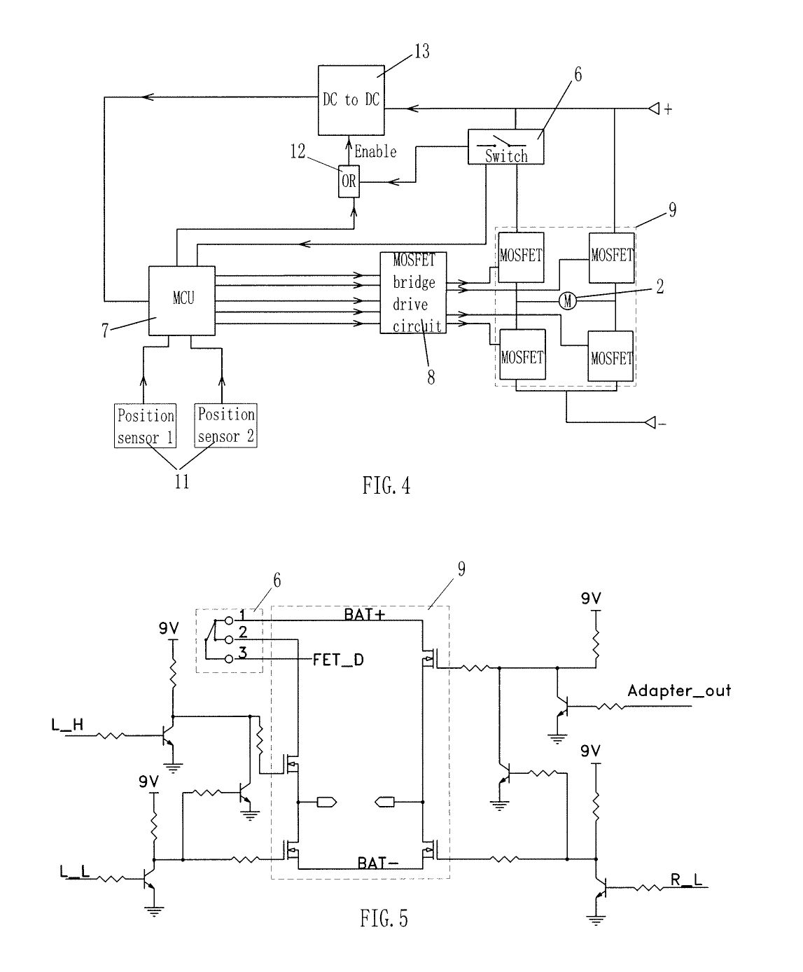

FIGS. 4 and 5 show a second embodiment of the control system of the branch-pruning shears of the present invention. The same reference numbers are used in both the figures for the second embodiment and the figures for the first embodiment. In the second embodiment, the switch 6 may be connected with the full-bridge circuit 9 to form a loop. As a result, the MOSFET bridge drive circuit 8 can control the rotation of the motor 2 only when the switch 6 is closed and the MCU 7 is actively sending out instructions.

The preceding control method is not limited to the branch-pruning shears described above. This method may also be used in other similar motor-driven shears known to those of ordinary skill in the art. Additionally, the control system is also not restricted in the contents mentioned above and the structures shown in the figures. Any obvious modifications, substitutions or changes to the shapes and the positions of other components and the elements based on the spirit of the present invention will be regarded as falling within the scope of this invention.

1. A method for controlling motor-driven shears, comprising the steps:
activating a switch;
actuating a micro controller;
wherein when the outputs of the switch and the micro controller are active simultaneously, a control system drives a motor to rotate a movable blade;
deactivating the switch, causing the micro controller to maintain causing the control system to drive the motor to rotate the movable blade to an open position; and
signaling the micro controller to stop the motor when the moveable blade is in a maximum open position.

2. A control method for motor-driven shears of claim 1, wherein the control system includes a MOSFET bridge drive circuit.

3. A control method for motor-driven shears of claim 2, wherein the switch and the micro controller are connected to the MOSFET bridge drive circuit through an AND gate circuit.

4. A control method for motor-driven shears of claim 3, wherein the AND gate circuit is composed of two diodes.

5. A control method for motor-driven shears of claim 1, wherein the control system includes a full-bridge circuit.

6. A control method for motor-driven shears of claim 5, wherein the switch is connected to the full-bridge circuit.

7. A control method for motor-driven shears of claim 5, wherein the full-bridge circuit is connected with the motor.

8. A control method for motor-driven shears of claim 5, wherein the full-bridge circuit is composed of MOSFETs.
